(19) United States
(12) Patent Application Publication
(10) Pub. No.: US 2006/0231013 A1
(43) Pub. Date: Oct. 19, 2006

(54) Oil pressure visual indicator

(75) Inventors: Glenn H. Lane, Chandler, AZ (US); James A. Wissinger, Carefree, AZ (US); William L. Giesler, Phoenix, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/109,074

(22) Filed: Apr. 18, 2005

(51) Int. Cl. G01L 19/12

(52) U.S. Cl. 116/272

(57) ABSTRACT

The present invention provides an apparatus for providing a visual indication of oil pressure comprising: a housing defining an exterior and an interior region wherein the interior region defines a sealing surface of the housing, the housing further defining an inlet providing fluid communication between the interior region of the housing and the exterior of the housing; a piston moveably disposed within the interior region of the housing so as to slide between a pressurized position and a depressurized position; a piston face defined by the piston wherein the piston face receives oil pressure admitted through the inlet and into the interior region of the housing; at least one low friction seal disposed on the piston so as to provide a sealing engagement between the piston and the sealing surface of the interior region of the housing; a visual indicator connected to the piston so that the visual indicator displays a visual indication of oil pressure when the piston is in the pressurized position; and a spring disposed within the housing so as to exert force on the piston when the piston moves from the depressurized position toward the pressurized position.

### FIELD OF THE INVENTION

The present invention relates to oil pressure indicators. More particularly, the present invention relates to a non-electric, oil pressure visual indicator suitable for use with aircraft turbine engines.

### BACKGROUND OF THE INVENTION

Numerous mechanical devices, motors, and engines depend on a pressurized lubrication system. Failure to supply a minimum oil pressure within the lubrication system of these devices can result in damage to the device. This, of course, is particularly true in the case of high rpm devices such as gas turbine engines. Some of these devices, engines, or motors that have a pressurized lubrication system do not have a means to warn the operator that the lubrication system is not receiving a minimum oil pressure. Therefore, it would be desired to provide a means of indicating the presence or absence of minimum oil pressure in these devices.

With certain machines, for example aircraft engines, it is sometimes desired to minimize unnecessary ancillary electrical components connected to the machine. Certain operators may specify a non-electrical device for measuring the presence of minimum oil pressure. Thus, whereas electrical devices that provide an oil pressure indication may be known, they are not suitable for certain applications. In such a case, a non-electrical method of providing a minimum oil pressure indication is needed.

In certain applications it is also important that an oil pressure indicator provide a high degree of non-leakage. For example, in gas turbine engines and other mechanical devices used in aircraft, it is desired to minimize oil leakage. However, the means to attain a minimally leaking or non-leaking oil pressure indicator is challenging when high oil pressures are present.

Hence there is an ongoing need to provide improved components that display oil pressure. It is desired that an oil pressure indicator be able to indicate the presence or absence of a minimum oil pressure. It is further desired that an oil pressure indicator be non-electrical in function. It is still further desired that an oil pressure indicator avoid or minimize any oil leakage from the device. The present invention addresses one or more of these needs.

### SUMMARY OF THE INVENTION

The present invention provides an apparatus and methods for providing a visual oil pressure indication. In one embodiment, and by way of example only, there is provided an apparatus for providing a visual indication of oil pressure comprising: a housing defining an exterior and an interior region wherein the interior region defines a sealing surface of the housing, the housing further defining an inlet providing fluid communication between the interior region of the housing and the exterior of the housing; a piston moveably disposed within the interior region of the housing so as to slide between a pressurized position and a depressurized position; a piston face defined by the piston wherein the piston face receives oil pressure admitted through the inlet and into the interior region of the housing; at least one low friction seal disposed on the piston so as to provide a sealing engagement between the piston and the sealing surface of the interior region of the housing; a visual indicator connected to the piston so that the visual indicator displays a visual indication of oil pressure when the piston is in the pressurized position; and a spring disposed within the housing so as to exert force on the piston when the piston moves from the depressurized position toward the pressurized position. In a further embodiment the low friction seal substantially restricts oil flow between the piston and the sealing surface of the interior region of the housing. In a further embodiment the piston further defines a groove and wherein the low friction seal is disposed in the groove of the piston. In a further embodiment the apparatus includes at least two low friction seals. In a further embodiment the low friction seal may comprises PTFE. In a further embodiment the housing comprises a first housing and a second housing. In a further embodiment the visual indicator is not extended when the piston is in the depressurized position. In a further embodiment the visual indicator includes gauge marks that indicate a level of oil pressure. In a further embodiment the spring is characterized by a spring constant such that the piston moves to the pressurized position when a threshold oil pressure is provided to the piston face. In a further embodiment the spring is characterized by a spring constant such that the piston moves to the depressurized position when a minimum oil pressure is not provided to the piston face. In a further embodiment the housing further defines a stop such that the piston is in the pressurized position when in contact with the stop. In a further embodiment the housing further defines a piston limit such that the piston is in the depressurized position when in contact with the piston limit.

In a further embodiment, and still by way of example, there is provided an apparatus for providing a visual indication of oil pressure received from an oil feed line comprising: a first housing; a second housing coupled to the first housing so as to define an interior region having a sealing service, the first housing and second housing further defining an inlet for admitting oil pressure to the interior region; a piston disposed in the interior region defined by the first housing and the second housing, wherein the piston can move between a pressurized position and a depressurized position within the interior region; a spring disposed in the interior region defined by the first housing and the second housing, wherein the spring contacts the piston so as to oppose motion of the piston toward the pressurized position; at least one low friction seal disposed on the piston wherein the low friction seal comprises PTFE, and wherein the low friction seal provides a sealing engagement between the piston and the sealing surface of the interior region of the housing; an indicator attached to the piston so as to provide a visual indication of oil pressure when the piston is in the pressurized position; and a nipple connected to the housing, wherein the nipple is shaped to receive the oil feed line and to provide oil pressure to the inlet. In a further embodiment the low friction seal further comprises an antiwear additive. In a further embodiment the spring is a linear force spring. In a further embodiment the spring is a nonlinear force spring. In a further embodiment the indicator further comprises gauge marks so as to indicate a degree of oil pressure.

In still a further embodiment, and still by way of example, there is provided a method for providing a visual oil pressure indication, the method comprising the steps of: providing oil through an inlet to an oil cavity so as to apply oil pressure on a piston face of a piston; moving a piston within a housing having a sealing surface, by the oil pressure on the piston face, from a depressurized position to a pressurized position; sliding low friction seals attached to the piston against the sealing surface of the housing so as to restrict oil leakage around the piston; compressing, by the movement of the piston to a depressurized position, a spring in contact with the piston; and moving an indicator attached to the piston so as to provide an oil pressure indication visible to a human observer when the piston moves to the pressurized position. The method may further include the steps of: removing oil pressure from the piston face; expanding the spring so as to move the piston from the pressurized position to the depressurized position; and moving an indicator attached to the piston such that the indicator provides an indication visible to a human observer of oil pressure below a minimum. The method may also include the step of displaying an oil pressure on the indicator.

Other independent features and advantages of the oil pressure visual indicator will become apparent from the following detailed description, taken in conjunction with the accompanying drawings which illustrate, by way of example, the principles of the invention.

### BRIEF DESCRIPTION OF THE DRAWINGS

FIG. 1 is a cross-sectional view of the oil pressure visual indicator in the pressurized position, according to an embodiment of the present invention; and

FIG. 2 is a cross-sectional view of the oil pressure visual indicator in the depressurized position, according to an embodiment of the present invention.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention. Reference will now be made in detail to exemplary embodiments of the invention, examples of which are illustrated in the accompanying drawings. Wherever possible, the same reference numbers will be used throughout the drawings to refer to the same or like parts.

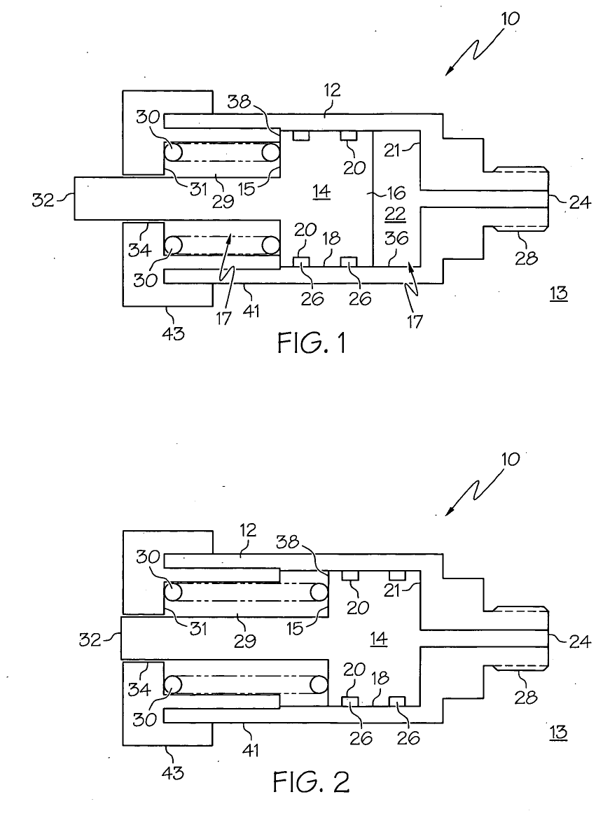

Referring now to FIG. 1 there is shown an embodiment of the oil pressure visual indicator 10. The oil pressure visual indicator 10 includes housing 12. Housing 12 defines a generally hollow interior region 17; housing also defines exterior area 13. Housing 12 further defines inlet 24 which is a passageway providing fluid communication between interior region 17 and exterior area 13. The interior region 17 of housing 12 is also defined by inner surface 36, piston limit 21, and spring surface 31. Housing 12 may comprise a unitary structure; preferably, however, housing may be assembled from subcomponents including first housing 41 and second housing 43.

Positioned within the interior region 17 of housing 12 is piston 14. It is noted that when piston 14 is disposed within housing 12 it separates interior region 17 into two sections, oil cavity 22 and spring cavity 29. In a preferred embodiment, piston 14 defines piston face 16. Piston face 16 is exposed to the fluid pressure that may be present within oil cavity 22 of housing 12. Piston 14 further defines sliding face 18, grooves 20, and piston surface 15. Preferably piston 14 is generally cylindrical in shape, and interior region 17 of housing 12 is also generally cylindrical in shape for receiving piston 14. However, other geometric configurations are possible.

Piston 14 is sized so that it may move freely within interior region 22 of housing 12. The limits of motion for piston 14 are the pressurized position and depressurized position. FIG. 1 shows piston 14 in the pressurized position, and FIG. 2 shows piston 14 in the depressurized position. In FIG. 1, piston 14 rests against stop 38. Piston 14 cannot extend farther once it comes into contact with stop 38. In FIG. 2 piston face 16 has come into contact with piston limit 21 and can extend no farther. FIG. 1 and FIG. 2 otherwise illustrate the same embodiment of the oil pressure visual indicator.

As shown in FIG. 1 spring 30 is disposed within spring cavity 29 of housing 12. Spring 30 contacts housing 12 at spring surface 31, and spring 30 also contacts piston 14 at piston surface 15. Spring 30 is noted to have different shapes in FIG. 1 and FIG. 2. Spring 30 is partially compressed in FIG. 1 when piston 14 is in the pressurized position. In FIG. 2, with piston 14 in the depressurized position, spring 30 is fully expanded and extends farther than shown in FIG. 1. As spring 30 is compressed it exerts a force against piston surface 15. As is known in the art, a force exerted by a spring is related to the degree of compression of the spring. This change in force is known as the spring constant or spring rate. Spring 30 may provide a spring constant with a linear or non-linear force response. Preferably, spring 30 is linear.

Still referring to FIG. 1 housing 12 is shown with indicator aperture 34 and indicator 32 protruding therethrough. Indicator 32 is preferably attached to piston 14 so that movement of piston 14 also causes a movement of indicator 32. In FIG. 1, with piston 14 in the pressurized position, indicator 32 extends through indicator aperture 34 beyond housing 12. This provides a visual indication to an observer of oil pressure. In FIG. 2, with piston 14 in the depressurized position, indicator 32 does not extend beyond housing 12. No visual indication from indicator 32 is present in FIG. 2. Thus indicator 32 is shaped so that movement of piston 14 between depressurized and pressurized positions causes indicator 32 to become visible beyond housing 12. Preferably indicator 32 includes a coloring or marking so as to provide a signal of oil pressure readily visible to a human observer. In other embodiments, indicator 32 may include gauge marks that provide an indication of specific oil pressure. It is additionally noted that the fit between aperture 34 and indicator 32 is preferably not an air tight fit. It is advantageous to allow air or gases in spring cavity 29 to escape through aperture 34 thus alleviating any backpressure in spring cavity 29.

As stated above, piston 14 is able to move within interior region 17. Sliding face 18 of piston 14 does not unduly contact inner surface 36 of housing 12 so as to restrict the movement of piston 14. However, low friction seals 26 provide a sealing engagement between piston 14 and inner surface 36 of interior region 17 of housing 12. Sealing engagement means a substantial restriction of oil leakage such as would be acceptable in aircraft applications. Low friction seals 26 are preferably disposed within grooves 20 on piston 14. Also preferably, a pair of low friction seals 26 is present.

In an alternative embodiment, low friction seals 26 may be disposed on housing 12 rather than on piston 14. In such an embodiment, low friction seals 26 may further comprise rod seals which are disposed in a groove or some other receiving structure on housing 12. It would also be preferred that a pair of rod seals be used. As before, low friction seals 26 disposed on housing 12 substantially restrict any oil leakage around seals 26. In still a further embodiment housing 12 may include a channel or passageway (not shown) to provide drainage of oil to a sump (not shown). Such a channel may be positioned in part in the area of housing between the two seals 26.

Low friction seals 26 are dynamic, slidable seals. Low friction seals allow easy, low friction movement of piston 14 within housing 12 so as not to restrict movement of piston 14, while substantially restricting any oil leakage around piston 14 as described further herein. They may be contrasted with static seals such as o-rings. A static seal or o-ring is designed for stationary use and tends to stick when used in a moveable structure. Low friction seals 26 are particularly suited to use in aircraft applications such as in aircraft engines and power units where it is desired to avoid oil leaks.

A suitable low friction seal includes those seals that include PTFE (polytetrafluoroethylene) as a low friction material. Other fluoroplastic compounds may also be used. An acceptable low friction seal should also be suitable for use in the high temperature range to be encountered with hot oils. Low temperatures may also be encountered, as with those devices used with aircraft engines, and the low friction seal should also be suitable at a low temperature range. Additionally, a low friction seal should be impervious to lubricating oils and other chemicals found in those materials. PTFE is a suitable material as it is chemically inert to nearly all industrial chemicals and solvents and does not unduly change properties or performance at typical temperature ranges. Antiwear additives may be included in the low friction seal such as, by ay of non-limiting example, ceramics, carbon, graphite, carbon-graphite, and polymers. As is known in the art, low friction seals 26 may include ridges and other physical features which assist in achieving very low leakage around the seal.

FIG. 1 and FIG. 2 also illustrate optional nipple 28 included on housing 12. Nipple 28 is an adapter to which may be attached an oil feed line (not shown). Nipple 28 thus provides a means to bring oil pressure from a remote engine or device into fluid communication with inlet 24.

Having described the oil pressure visual indicator 10 from a structural standpoint, a method of using the apparatus will now be described.

The oil pressure visual indicator 10 is disposed so as to provide oil pressure to inlet 24 of housing 12. In a preferred embodiment this is accomplished by attaching an oil feed line to nipple 28. Known methods are preferably used to bleed the oil feed line so as to avoid the presence of gas bubbles and vapor in either the feed line or inlet 24. Oil and oil pressure is then admitted to inlet 24 whereupon the oil extends to oil cavity 22. Oil that enters oil cavity 22 contacts piston face 16 thereby exerting a force on piston 14. This force tends to move piston 14 to the pressurized position. Oil does not significantly leak past low friction seals 26.

Movement of piston 14 from piston limit 21 tends to compress spring 30. Thus, as oil pressure tends to move piston 14 to the pressurized position, piston 14 encounters a counteracting force from spring 30. The force of spring 30 tends to move piston 14 in the opposite direction (from what the oil pressure urges), toward the depressurized position. It will thus be appreciated that various forces and dimensions are here balanced so that a set oil pressure provides sufficient force on piston face 16 so as to move piston 14 to the pressurized position. More particularly, the surface area of piston face 16 is determined so that a given pressure acting thereon develops a desired force. This oil pressure derived force is sufficient to overcome the force of spring 30 and any other frictional forces. Spring 30 is thus selected with spring constant K such that spring 30 is compressed by the desired force. The spring constant K multiplied by the stroke of the spring results in a spring force that, together with other frictional forces, is overcome by the minimum oil pressure force. Stroke refers to the linear distance traversed by piston 14 and spring 30 in moving from the depressurized position to the pressurized position. Should the oil pressure fall below the set pressure, then the force of spring 30 overcomes the oil pressure force on piston face 16. Preferably, the set oil pressure described in this paragraph is a minimum oil pressure. Thus, if the system oil pressure falls below that minimum oil pressure indicator 34 will be retracted. Conversely, oil pressures at and above the minimum oil pressure will extend indicator 34.

The selection of spring 30, which affects how the oil pressure indicator 10 will respond to oil pressure, thus allows for varying configurations. In one embodiment, the oil pressure visual indicator 10 is configured to operate as a pop out button. In this embodiment, a minimum oil pressure provides sufficient force on the piston face 16 to move piston 14 to the pressurized position. Spring 30 is selected such that it fully compresses to the pressurized position upon receiving the force associated with the minimum pressure. In this embodiment, with piston 14 in the pressurized position, indicator 32 provides its fully extended signal that minimum oil pressure is present. However, indicator 32 does not provide significant information regarding gradual changes in oil pressure above the minimum oil pressure as there is a range of oil pressures above the minimum oil pressure that does not induce further movement of piston 14. The use of a belville stack selected with a resistance close to the snap-through force is one way to configure the pop out button embodiment. Additionally, a Smally Crest-to-Crest® wave spring may be selected that would also allow the indicator to stroke to its full indication position at a selected sensitivity pressure.

In an alternative embodiment, a gradual increase in oil pressure above a minimum pressure acts to gradually increase the movement of piston 14 from the depressurized position and toward the pressurized position. Below the minimum oil pressure, the oil pressure is insufficient to overcome the force exerted by spring 30, and piston 14 remains in the depressurized position where piston face 16 contacts piston limit 21. As oil pressure increases above the minimum oil pressure, the movement of piston 14 continues until oil pressure reaches a threshold pressure. At the threshold pressure, piston 14 contacts stop 15 and is in the pressurized position. The range of movement of piston 14 between the depressurized position and the pressurized position thus corresponds to a range of oil pressures, which may be reflected by gauge marks on indicator 32. While this embodiment is useful for providing an indication of oil pressure, it may not provide as clear an indication that only a minimum oil pressure is present compared to the pop out embodiment.

Housing 12 was earlier described as preferably composed of subcomponents such as first housing 41 and second housing 43. This is advantageous in using the apparatus in that housing 12 may be disassembled, cleaned and reassembled. Parts that may be subject to periodic wear such as spring 30 and low friction seals 26 may be replaced by disassembling housing 12. Housing components may be coupled by known methods such as, but not limited to, reciprocal threading and press fitting.

Some component specifications are now described as one exemplary embodiment of the oil pressure visual indicator. A piston is selected with diameter of 0.864 inches and a piston face area of 0.586 inches². The static friction, F_{drag}, corresponding to the force required to move the low friction seals from rest, is 2.55 lbs. A spring for this application is specified as having a spring constant of 26.97 lb/in. The spring has a free height of 1.312 in, an installed height (height of spring in the depressurized position) of 1.0 inch, and a compressed height (height of spring in pressurized position) or 0.7 in. It is noted that in this example, the spring has an installed compression corresponding to the spring free height minus the installed height. Thus, in the depressurized position, the spring already exerts an initial force on the piston that is determined by the spring constant multiplied by the installed compression. This is calculated as (26.97 lb/in)(1.312 in−1.0 in)=8.4 lb. At the pressurized position the spring exerts a force, Fₘₐₓ, of 16.5 lbs, which is calculated by the formula K X stroke=(26.97 lb/in)(10.312 in−0.7 in). Thus, the pressure required to fully move the piston to the pressurized position is (Fₘₐₓ+F_{drag})/piston area=(16.5 lb+2.55 lb)/0.586 in²=32.5 psi. Hence, this system is compatible with engine systems that require an indication of minimum oil pressure at approximately 32.5 psi. This is an example of one oil pressure indicator configuration as there are numerous piston diameters, oil pressures, and spring sizes that can be used.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for providing a visual indication of oil pressure comprising:
a housing defining an exterior and an interior region wherein the interior region defines a sealing surface of the housing, the housing further defining an inlet providing fluid communication between the interior region of the housing and the exterior of the housing;
a piston moveably disposed within the interior region of the housing so as to slide between a pressurized position and a depressurized position;
a piston face defined by the piston wherein the piston face receives oil pressure admitted through the inlet and into the interior region of the housing;
at least one low friction seal disposed on the piston so as to provide a sealing engagement between the piston and the sealing surface of the interior region of the housing;
a visual indicator connected to the piston so that the visual indicator displays a visual indication of oil pressure when the piston is in the pressurized position; and
a spring disposed within the housing so as to exert force on the piston when the piston moves from the depressurized position toward the pressurized position.

2. The apparatus according to claim 1 wherein the low friction seal substantially restricts oil flow between the piston and the sealing surface of the interior region of the housing.

3. The apparatus according to claim 1 wherein the piston further defines a groove and wherein the low friction seal is disposed in the groove of the piston.

4. The apparatus according to claim 1 further comprising at least two low friction seals.

5. The apparatus according to claim 1 wherein the low friction seal comprises PTFE.

6. The apparatus according to claim 1 wherein the housing comprises a first housing and a second housing.

7. The apparatus according to claim 1 wherein the visual indicator is not extended when the piston is in the depressurized position.

8. The apparatus according to claim 1 wherein the visual indicator further comprises gauge marks that indicate a level of oil pressure.

9. The apparatus according to claim 1 wherein the spring is characterized by a spring constant such that the piston moves to the pressurized position when a threshold oil pressure is provided to the piston face.

10. The apparatus according to claim 1 wherein the spring is characterized by a spring constant such that the piston moves to the depressurized position when a minimum oil pressure is not provided to the piston face.

11. The apparatus according to claim 1 wherein the housing further defines a stop such that the piston is in the pressurized position when in contact with the stop.

12. The apparatus according to claim 1 wherein the housing further defines a piston limit such that the piston is in the depressurized position when in contact with the piston limit.

13. An apparatus for providing a visual indication of oil pressure received from an oil feed line comprising:
a first housing;
a second housing coupled to the first housing so as to define an interior region having a sealing service, the first housing and second housing further defining an inlet for admitting oil pressure to the interior region;
a piston disposed in the interior region defined by the first housing and the second housing, wherein the piston can move between a pressurized position and a depressurized position within the interior region;
a spring disposed in the interior region defined by the first housing and the second housing, wherein the spring contacts the piston so as to oppose motion of the piston toward the pressurized position;
at least one low friction seal disposed between the piston and the sealing surface of the interior region, wherein the low friction seal comprises PTFE, and wherein the low friction seal provides a sealing engagement between the piston and the sealing surface of the interior region of the housing;
an indicator attached to the piston so as to provide a visual indication of oil pressure when the piston is in the pressurized position; and
a nipple connected to the housing, wherein the nipple is shaped to receive the oil feed line and to provide oil pressure to the inlet.

14. The apparatus according to claim 13 wherein the low friction seal further comprises an antiwear additive.

15. The apparatus according to claim 13 wherein the low friction seal comprises a rod seal.

16. The apparatus according to claim 13 wherein the low friction seal is disposed on the interior surface of the housing.

17. The apparatus according to claim 13 wherein the indicator further comprises gauge marks so as to indicate a degree of oil pressure.

18. A method for providing a visual oil pressure indication, the method comprising the steps of:
providing oil through an inlet to an oil cavity so as to apply oil pressure on a piston face of a piston;
moving a piston within a housing having a sealing surface, by the oil pressure on the piston face, from a depressurized position to a pressurized position;
sliding low friction seals attached to the piston against the sealing surface of the housing so as to restrict oil leakage around the piston;
compressing, by the movement of the piston to a depressurized position, a spring in contact with the piston; and
moving an indicator attached to the piston so as to provide an oil pressure indication visible to a human observer when the piston moves to the pressurized position.

19. The method according to claim 18 further comprising the steps of:
removing oil pressure from the piston face;
expanding the spring so as to move the piston from the pressurized position to the depressurized position; and
moving an indicator attached to the piston such that the indicator provides an indication visible to a human observer of oil pressure below a minimum.

20. The method according to claim 18 further comprising the step of displaying an oil pressure on the indicator.
